(19) United States
(12) Patent Application Publication
(10) Pub. No.: US 2002/0155839 A1
(43) Pub. Date: Oct. 24, 2002

(54) Allocation of control channel in a communication system

(75) Inventor: Rex A. Nisbet, Christchurch (NZ)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Tait Electronics Limited

(21) Appl. No.: 09/847,322

(22) Filed: May 3, 2001

(30) Foreign Application Priority Data
Apr. 18, 2001 (NZ) NZ 511155

(51) Int. Cl. H04Q 7/20

(52) U.S. Cl. 455/450; 455/509; 455/434; 455/515; 455/11.1

(57) ABSTRACT

The invention involves a proactive shift of a control channel among a range of available channels in a mobile radio network, particularly traffic channels. The control channel is intermittently shifted in a periodic or non-periodic manner, thereby making the frequency available for use in other networks. A round-robin process may be used to re-allocate the control channel among traffic channels. This is useful in a network operating within a common channel environment where activity on a fixed the control channel can be unfair or interfere with other networks.

### BACKGROUND OF THE INVENTION

1. Field of the Invention

This invention relates to communication networks and to operation of a base station in a network for mobile radios. In particular but not solely, the invention relates to a system for allocation of a control channel at a base station in a trunked network that is compliant with international MPT standards.

### BACKGROUND ART

Mobile radio networks such as those prescribed by MPT 1327 and MPT 1343 are designed to accommodate large numbers of mobile units in a limited radio frequency spectrum. The networks are divided into geographical cells within which trunking allows users of the mobile units to share a relatively small number of channels. Each call between two or more users is allocated a channel from a pool of available channels in a local cell, and on termination of a call, the channel is returned to the pool. Each cell is generally under control of a base station that provides the channels by way of a series of repeaters, perhaps up to a dozen or more. Each repeater generally includes transmitter and receiver devices that provide uplink and downlink portions of a particular channel. The channels are usually based on a frequency division multiple access (FDMA) transmission system although time division and other systems are also used. The base stations are usually linked to regional controllers, typically in groups of up to a dozen or more, depending on user requirements, and the regional sites may in turn be linked to form a wider network. Communication systems of this kind are also usually linked to other services such as public telephone networks and the Internet.

One or more of the channels in a cell usually acts as a control channel, broadcasting and receiving control data between the base station and the mobile units by a transmission technique such as fast frequency shift keying (FFSK). Mobile radios in the cell make and respond to calls by way of the control channel and generally monitor the channel for network information. The other channels in a cell are usually available as traffic channels for voice or data communication between users. Repeater equipment is generally identical for channels of all kinds, with specific control and traffic channels being determined when a new base station is installed. Each new call in a cell is dynamically allocated a traffic channel from the pool provided by the base station. If no traffic channels are available at that time then the call is usually queued and a channel is allocated as soon as possible. In some networks calls that cannot be connected are simply cleared back to the mobile unit and the user must try again later. Various systems exist for temporarily allocating the control channel as a traffic channel if required. Various systems also exist for allocating a traffic channel as the control channel in the event of an equipment failure.

Several radio communication networks may operate in a common environment, and may create problems of unfair access and interference. Use of the radio frequency spectrum is limited by law in most countries, with a licence usually being required to operate a network, and sometimes an overlap between channels of independent networks cannot be avoided. In particular, a base station must usually transmit continuously on a respective control channel thereby affecting use of that channel at nearby stations in other networks. Another station that attempts to share the control channel for any purpose will generally cause interference and neither station may be able to operate effectively.

### BRIEF SUMMARY OF THE INVENTION

It is an object of the present invention to provide a system for improved allocation of a control channel in a mobile radio network, typically a network operating within a common channel environment, or at least to provide an alternative to existing systems. In general terms, the invention involves a proactive shift of a control channel among a range of available channels, particularly traffic channels. The control channel is intermittently shifted in a periodic or non-periodic manner, thereby making the channel available for use in other networks.

In one aspect the invention may be said to consist in a base station for a mobile radio system, including: a plurality of repeaters that provide respective radio channels, a station controller connected to each repeater, and a radio antenna system connected to the repeaters, wherein the repeaters provide a control channel and a plurality of traffic channels for mobile users, with allocation of the control channel being varied among the traffic channels. Preferably the control channel is changed periodically from one repeater to another in a round-robin or random process.

In another aspect the invention may also be said to consist in a method of providing radio channels in a mobile communication system, including: allocating a control channel and a plurality of traffic channels for mobile radios in the system, and intermittently re-allocating the control channel as a traffic channel and one of the other traffic channels as a new control channel. Preferably a new channel is selected for re-allocation of the control channel by determining a free traffic channel in a channel control system.

In a further aspect the invention may be said to consist in a method of reallocating a control channel in a radio base station, including: selecting an existing traffic channel to become a new control channel according to a predetermined process, denying new requests by mobile radios over a current control channel for access to traffic channels, completing existing requests by mobile radios over the current control channel for access to traffic channels, allocating the selected traffic channel as the new control channel and the current control channel as a traffic channel, and receiving new requests by mobile radios over the new control channel for access to traffic channels.

The invention includes a radio network having a base station or otherwise implementing a method according to any one of these aspects.

### BRIEF DESCRIPTION OF THE FIGURES

Preferred embodiments of the invention will be described with respect to the accompanying drawings.

FIG. 1 shows a base station and a plurality of mobile units in a radio communication system.

FIG. 2 indicates a method by which a station controller can change a control channel in FIG. 1.

FIG. 3 indicates another base station in more detail than that of FIG. 1.

FIGS. 4 and 5 show simple signal structures that can be transmitted by the base station to the mobile units during a change of control channel.

FIG. 6 indicates a method by which a channel controller can change a control channel in FIG. 3.

FIG. 7 indicates a method by which other channel controllers can respond in relation to the controller in FIG. 6.

FIG. 8 indicates a method by which a waiting mobile unit can respond in relation to the controller in FIG. 6.

FIG. 9 indicates a method by which a calling unit can respond in relation to the controller in FIG. 6.

FIG. 10 indicates a method by which an idle unit can respond in relation to the controller in FIG. 6.

### DETAILED DESCRIPTION OF THE INVENTION

Referring to the figures it will be appreciated that the invention may be implemented in a range of different ways in a range of different mobile radio networks. The systems described here are given by way of example only. Skilled readers will also appreciate that many known details of radio equipment and processes, not directly relevant to the invention, have been omitted for clarity.

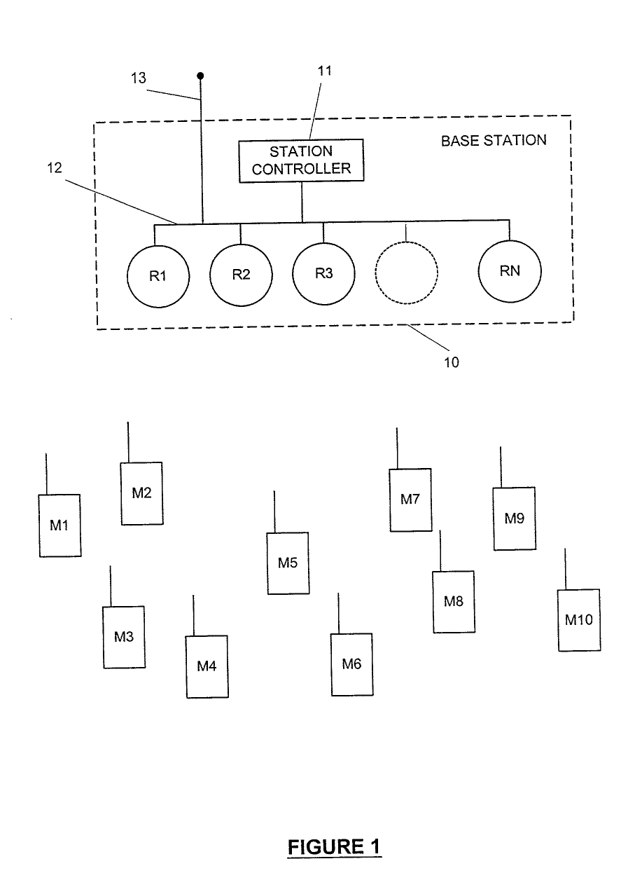

FIG. 1 shows a simplified base station 10 serving a number of mobile units MI-M1 0 in a cell of a radio network, typically a network that is compliant with a standard such as MPT 1327. The station includes a number of repeaters RI-RN connected to a main controller 11 by a communication bus 12. The controller is usually a computer-based device having standard components such as a microprocessor, memory devices, power supply and connection ports. Each repeater generally provides a duplex radio channel by way of transmitter and receiver devices that operate on predetermined frequencies, and includes other components that have not been shown. Transmitter and receiver devices in the base station are usually connected to a common antenna system that has also been omitted. In this example, the station controller determines the operation of each repeater over the communication bus, although in other stations the repeaters may have more autonomy and interaction with each other by way of individual channel controllers. The bus may be connected to a regional control node or to other networks in various ways, indicated schematically by a port 13. Mobile units may be provided in many forms each having generally standard components including a microprocessor, memory, radio transceiver, power supply and antenna.

In this example, the repeater R1 is initially considered to provide a control channel while the repeaters R2-RN provide a pool of traffic channels. A control signal containing information in standard message codes is transmitted by repeater R1 on the control channel, while information including requests for calls from the mobile units is received. More than one control channel is required in some networks. Mobile units within the cell and not calling, are generally idle and listening to transmissions on the control channel. Other units participating in calls within the cell form groups of two or more that are transmitting and receiving on particular traffic channels. Individual units may be participating in calls to other units or entities outside the cell, and also use respective traffic channels. There are usually many more mobile units than traffic channels, with the numbers of each having been determined by user requirements when the network was installed. A unit attempting to make a call determines from the control channel whether a request can be made, and if so transmits a request, also on the control channel. The unit then waits for a reply from the station controller on the control channel, including information such as availability of the called unit and allocation of a traffic channel. If there are no traffic channels available then the calling unit is normally placed in a queue and waits for further information. Calling units are generally not able to receive or transmit on the control channel, and are only able to resume listening to the control channel when a call has been completed.

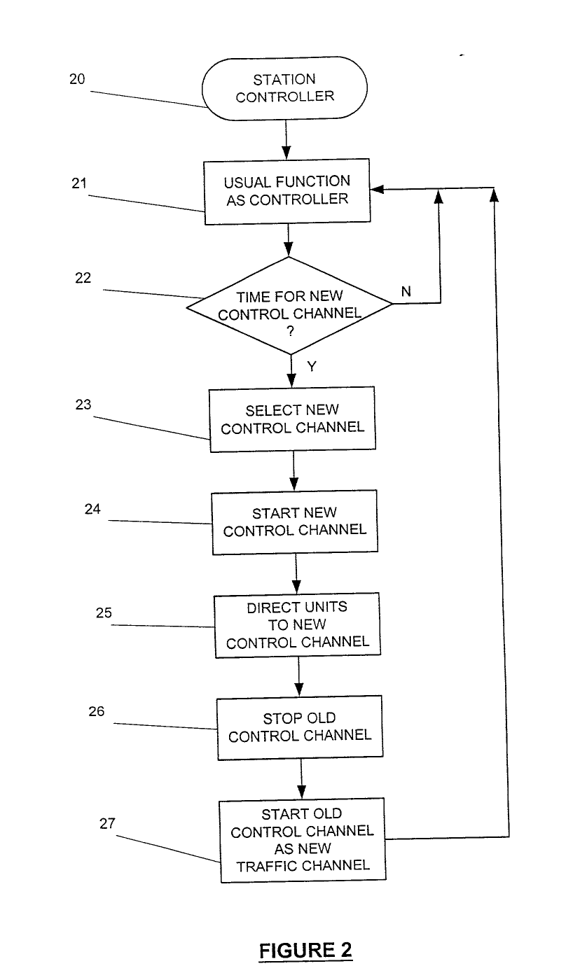

FIG. 2 is a flow diagram outlining how the base station 10 in FIG. 1 might intermittently shift the control channel among the repeaters R1-RN. The station controller 11 runs a software system 20 that carries out many important functions during operation of the base station, all represented by step 21. This includes transmission of a control signal on a control channel currently provided by repeater R1. In step 22 the controller system decides that a new control channel must be allocated, for example at regular or random intervals, or according to some other predetermined scheme. The controller then determines a new control channel in step 23, generally by selection from the existing traffic channels. For example, the repeaters may be considered on a round-robin or random basis according to an activity table maintained by the controller. Channels that are currently busy with traffic may be skipped, or the controller may simply wait until the next channel in a list becomes available. In step 24 the controller starts the new control channel by directing a particular repeater, such as R2, to begin transmission of a valid control signal. Mobile units are then directed in step 25 to listen on the new control channel, usually by way of information transmitted on the existing control channel.

Transmission of a control signal on the old control channel then ceases in step 26 and the repeater may or not be allocated for ongoing use as a traffic channel in step 27. The controller returns to usual functions.

Many variations of this operational outline are possible. For example, the control channel could be maintained at a particular repeater and shifted by changing the frequency of the repeater. The frequency of a traffic channel currently provided by another repeater would be changed in correspondence. This would require relatively sophisticated repeaters with suitable frequency agility, other than those which normally operate on a fixed frequency. Also, the mobile units need not be actively directed to a new control channel but might be left to simply scan the current channels for the new control signal. This is relatively inefficient and wastes the time required by the units to carry out scans. Another variation involves shift of the control channel by individual channel controllers in the repeaters, as described below. This is more complex than changes implemented by a main controller but is more appropriate to many base stations and networks that are currently in use. The rate of change of control channel may also be varied to suit particular circumstances, with rates of perhaps once a minute, once a day, or any other rate, as required.

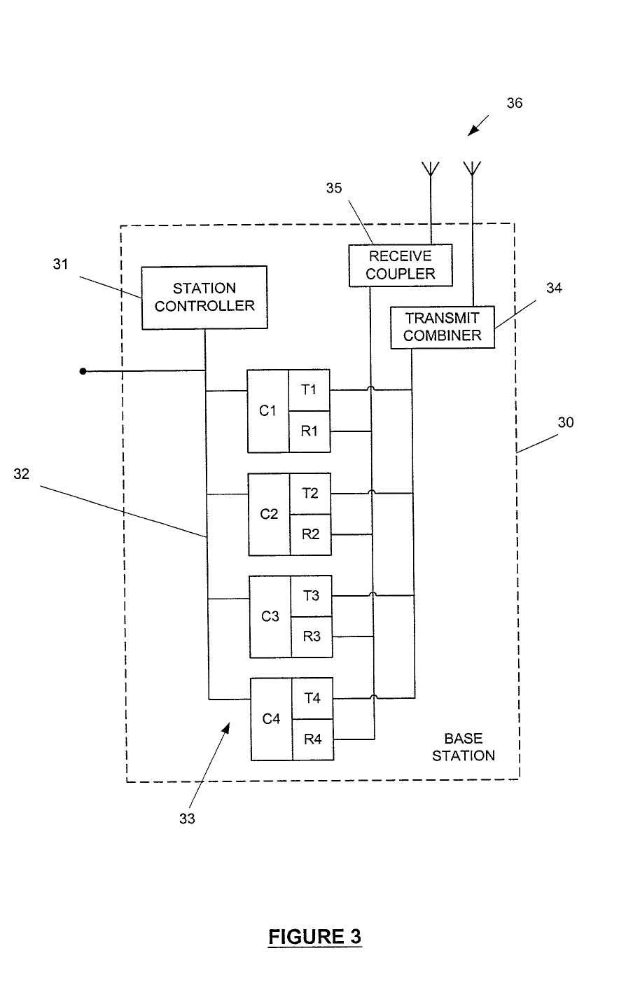

FIG. 3 shows a base station 30 similar to that of FIG. 1 but capable of operation in a different manner. A station controller 31 is connected through bus 32 to four repeaters 33, by way of example. The repeaters are shown with respective transmitter and receiver devices T1-T4 and R1-R4, and with individual channel controllers C1-C4. The controllers are typically computer-based devices including a microprocessor, memory systems, and input/output ports. Individual repeaters 33 and their channel controllers play a greater role in this example, with one of the channel controllers C1-C4 being directly responsible for the control channel and control signal at any time, although the station controller 31 still maintains overall control over the repeaters. In practice there could be many more repeaters, as indicated in FIG. 1, and each would normally have several other components such as a power supply and external connections. The transmitters T1-T4 are connected on a common output line to a combiner 34 while the receivers R1-R4 are connected on a common input line to a coupler 35. A pair of antennae 36 are provided for transmission and reception of radio signals by the combiner and coupler respectively. As before, the repeaters 33 generally have the same structure and capability and are capable of functioning as either a control channel or a traffic channel.

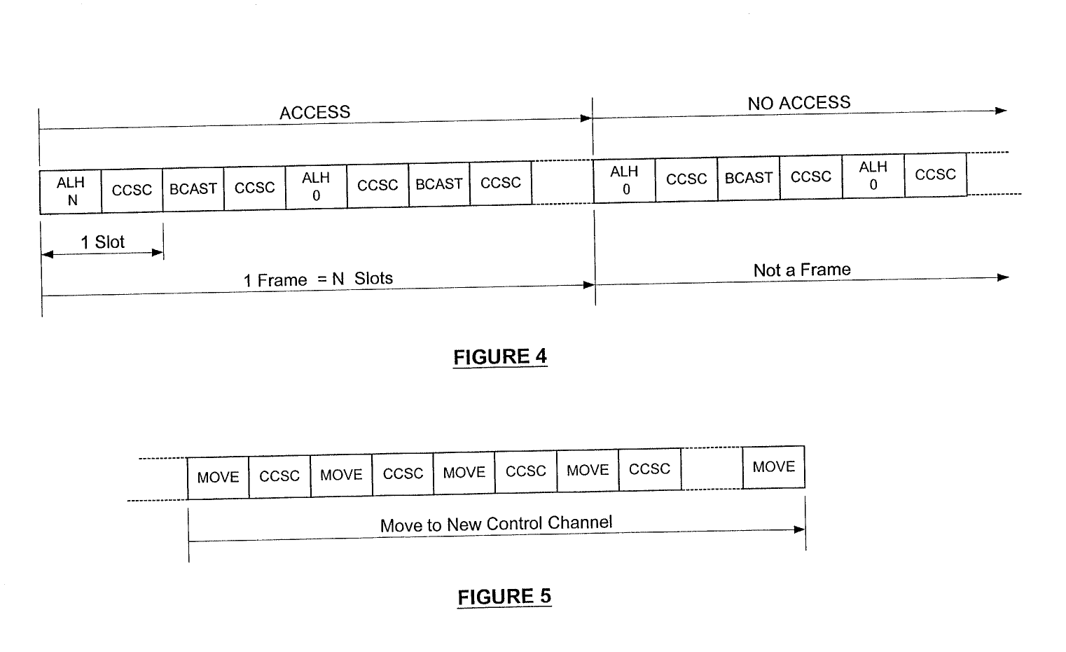

FIGS. 4 and 5 indicate parts of a control signal that might be generated by one of the channel controllers C1-C4 when providing a control channel in base station 30 of FIG. 3. The signal generally includes several time slots containing coded information that is required under MPT 1327 or another mobile radio standard. The slots may or may not form frames as described below. In this example CCSC is an MPT code transmitted in each slot that identifies the base station and aids synchronisation of the mobile units, while BCAST contains various network parameters. FIG. 4 indicates a change in the control signal as the channel controller undergoes a transition from inviting to forbidding messages by mobile units requesting access to traffic channels. The channel is typically about to finish as a control channel and can no longer be responsible for set up of calls between the units. A new control channel has or will shortly be allocated. ALH is an MPT code used for invitations of random access messages by the units. Parameter N if non-zero, indicates the beginning of a frame and the total number of slots that will follow in the frame. Access messages are only permitted within a frame comprising N slots after ALH N. Parameter N if zero, indicates a filler within the frame or within an interval when access messages are forbidden. FIG. 5 indicates a subsequent control signal directing mobile units to a new control channel. MOVE is an MPT code containing information relating to the new channel.

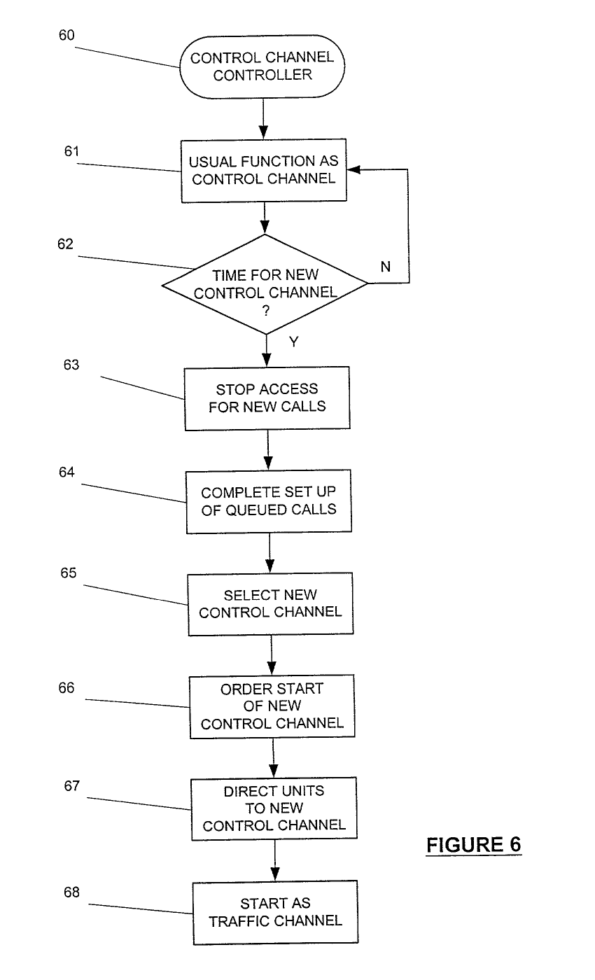

FIG. 6 is a flow diagram outlining how the base station 30 in FIG. 3 might intermittently shift the control channel among repeaters 33. One of the channel controllers such as C1 is initially considered to determine the control channel, running a software system 60. Incidental functions of the system are represented by step 61, including generation of a normal control signal, transmission of the signal through transmitter T1 and reception of access messages through receiver R1. Other usual functions may include queuing of calls when all traffic channels are busy. In step 62 the controller decides that a new control channel must be allocated, generally according to a predetermined scheme as mentioned before. The controller then forbids access messages in step 63 by changing the control signal as indicated in FIG. 4, for example. Queued calls may be set up in step 64 and other usual functions may also be completed. A new control channel is selected in step 65, generally by selection from existing channels as before. The controller typically polls the other controllers over the communication bus to determine their availability to provide the control channel. In step 66 the controller then directs an appropriate controller such as C2 to start a new control channel, generally in place of a traffic channel that is no longer busy. The controller directs mobile units to the new control channel in step 67, as indicated in FIG. 5 for example, and in step 68 usually but not necessarily offers a traffic channel.

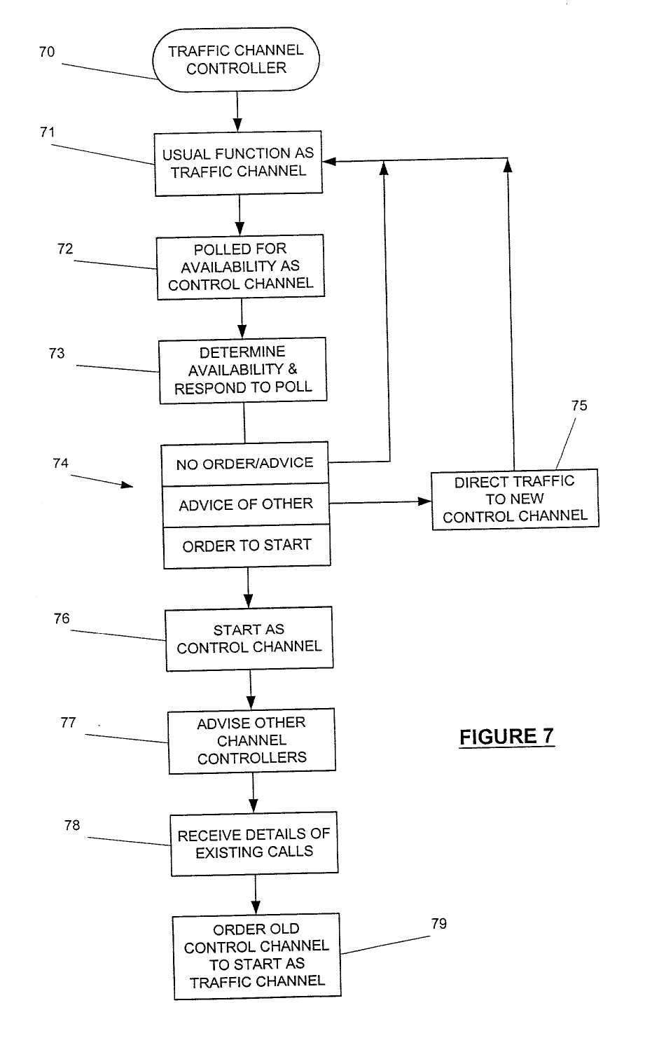

FIG. 7 is a flow diagram outlining how a channel controller such as C2, providing a traffic channel, responds in the flow of FIG. 6. The controller operates a software system 70, generally but not necessarily the same as system 60 at any instant, having usual functions for a traffic channel represented by step 71. In step 72 the controller C2 is polled by controller C1 for availability to provide a new control channel, and responds in step 73. There are three main subsequent possibilities, represented by step 74. Irrespective of the response, there may be no further direction by controller C1 for some reason at this stage, in which case the controller C2 along with others such as C3 and C4, continue normal functions. Again irrespective of the response, the controller C1 may select another controller to provide the new control channel, in which case advice is normally received from the other controller. Controller C2 then continues to provide a traffic channel and generally directs any calling units on that channel to the new control channel when their calls are completed in step 75, and returns to normal functions. Alternatively if the response is positive, the controller C1 may select C2 to provide the control channel. Controller C2 then starts the control channel in step 76, advises the other controllers accordingly in step 77, and receives details from C1 of existing calls underway at the base station in step 78. Finally, C2 takes responsibility for the control channel by directing C1 to provide a traffic channel as required.

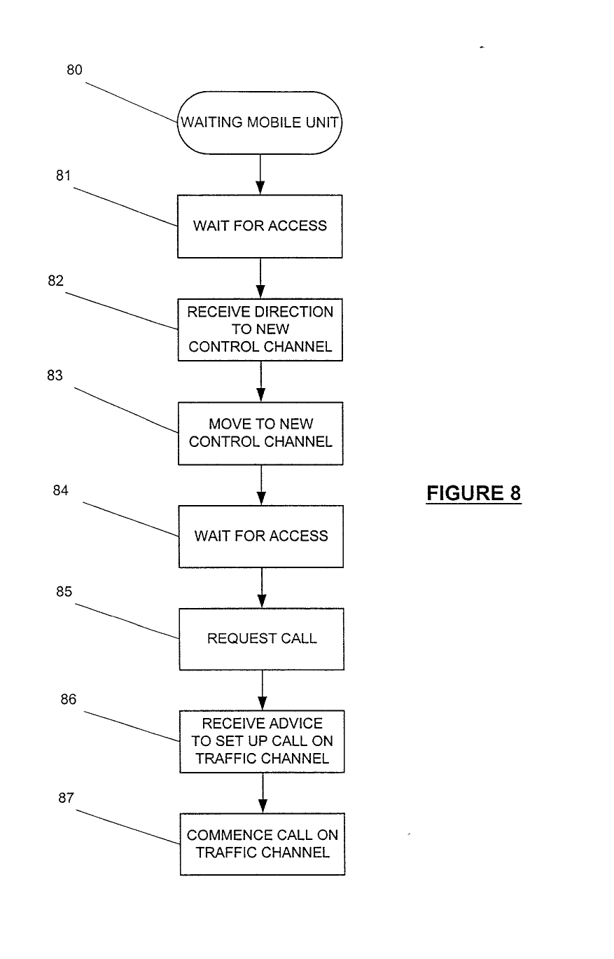

FIGS. 8, 9 and 10 are flow diagrams outlining typical operation of mobile units during a change of control channel according to FIGS. 6 and 7. In FIG. 8 a mobile unit with an operating system 80 and in step 81 is waiting to request access from controller C1 for a call. In this example the request is not permitted by C1 but instead the unit is directed and moves to the new control channel provided by C2, in steps 82 and 83. The unit then waits in step 84 for permission to send an access message on the new channel. An invitation to request access is eventually transmitted on the new control channel, and a request is made by the unit in step 85. A response from C2 arrives in step 86, including allocation of a traffic channel, perhaps provided by C1, and the call commences in step 87.

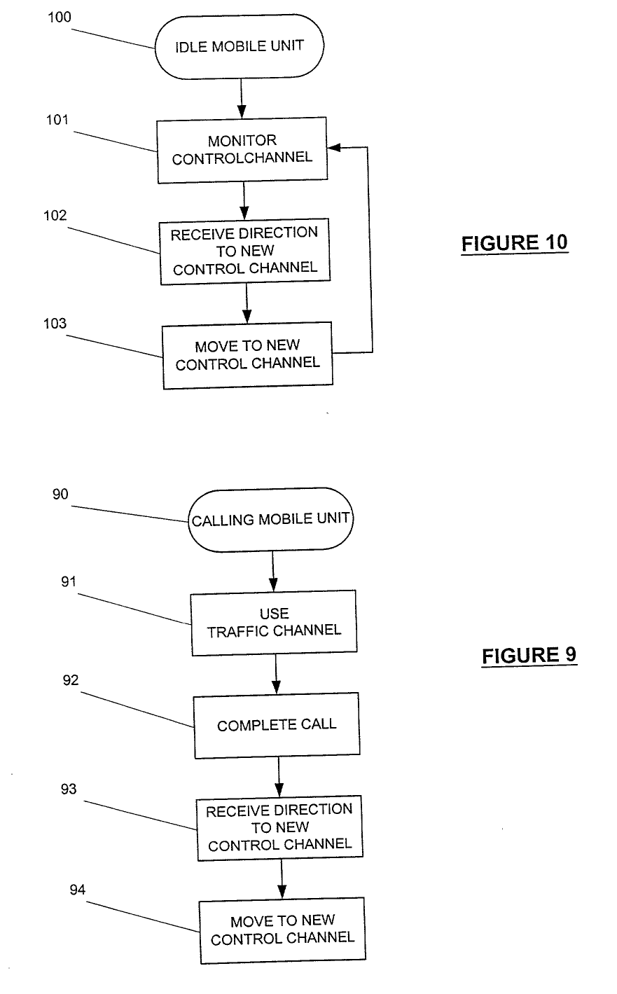

FIG. 9 briefly outlines the behavior of a mobile unit that is calling during the change of control channel in FIGS. 6 and 7. The unit has an operating system 90 that is currently performing a call on a traffic channel in step 91. The call is completed in step 92, usually on termination by the user. The unit first returns to the control channel that initially allocated the traffic channel for the call, and receives advice of the new control channel in step 93. It then simply changes to monitor the new channel and becomes idle in step 94.

FIG. 10 briefly outlines the behavior of a mobile unit that is idle during change of the control channel in FIGS. 6 and 7. The unit has an operating system 100 that simply monitors the current control channel for network information in step 101. A direction is received on the control channel in step 102 for a move to a new control channel. In step 103 a transceiver in the unit simply changes to monitor the frequency of the new channel.

What is claimed is:

1. A base station for a mobile radio system, including:
a plurality of repeaters that provide respective radio channels;
a station controller connected to each repeater; and
a radio antenna system connected to the repeaters;
wherein the repeaters provide a control channel and a plurality of traffic channels for mobile users, with allocation of the control channel being varied among the traffic channels.

2. A base station according to claim 1, wherein:
the control channel is changed periodically from one repeater to another in a round robin process.

3. A base station according to claim 1, wherein:
the control channel is changed periodically or non-periodically among the repeaters in a random process.

4. A base station according to claim 1, wherein:
each repeater normally provides a traffic channel and the control channel is changed intermittently among the repeaters according to a predetermined process skipping those repeaters at which the traffic channel is busy.

5. A base station according to claim 1, wherein:
allocation of the control channel among the repeaters is determined by the station controller.

6. A base station according to claim 1, wherein:
each repeater includes a channel controller and allocation of the control channel from one repeater to another is determined by respective channel controllers.

7. A method of providing radio channels in a mobile communication system, including:
allocating a control channel and a plurality of traffic channels for mobile radios in the system; and
intermittently re-allocating the control channel as a traffic channel and one of the other traffic channels as a new control channel.

8. A method according to claim 7, further including:
re-allocating the control channel among the traffic channels on a round robin basis.

9. A method according to claim 7, further including:
re-allocating the control channel among the traffic channels on a random basis.

10. A method according to claim 7, further including:
selecting a channel for re-allocation of the control channel by determining a free traffic channel in a channel control system.

11. A method of re-allocating a control channel in a radio base station, including:
selecting an existing traffic channel to become a new control channel according to a predetermined process;
denying new requests by mobile radios over a current control channel for access to traffic channels;
completing existing requests by mobile radios over the current control channel for access to traffic channels;
allocating the selected traffic channel as the new control channel and the current control channel as a traffic channel; and
receiving new requests by mobile radios over the new control channel for access to traffic channels.

12. A method according to claim 11, wherein:
the predetermined process includes a round robin poll of traffic channels to locate a channel not currently busy with traffic.

13. A method according to claim 12, wherein:
the poll takes place at periodic or random intervals.

14. A radio network including a base station that implements a method according to claim 7.

15. A radio network including a base station that implements a method according to claim 8.

16. A radio network including a base station that implements a method according to claim 9.

17. A radio network including a base station that implements a method according to claim 10.

18. A radio network including a base station that implements a method according to claim 11.

19. A radio network including a base station that implements a method according to claim 12.

20. A radio network including abase station that implements a method according to claim 13.
